(19) United States
(12) Patent Application Publication
(10) Pub. No.: US 2008/0270842 A1
(43) Pub. Date: Oct. 30, 2008

(54) COMPUTER OPERATING SYSTEM HANDLING OF SEVERE HARDWARE ERRORS

(76) Inventors: JenChang Ho, San Jose, CA (US); Shashi Kanth Lakshmikantha, Sunnyvale, CA (US); Vishwas Pandian Durai, Santa Clara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/740,852

(22) Filed: Apr. 26, 2007

(51) Int. Cl. G06F 11/00

(52) U.S. Cl. 714/42

(57) ABSTRACT

A system and method is provided for handling severe hardware errors communicated to a computer operating system as an abort indication. The method includes classifying the type of abort into a memory-related error or non-memory-related error. For memory-related errors, a debug file is written that includes error source information for an affected process without accessing the affected process memory.

### BACKGROUND

Debugging software can be a tedious endeavor. Even well designed and implemented programs sometimes have unexpected interactions and side effects that cause programs and/or computer systems to fail. A variety of tools exist to help in debugging software, including for example, debugging programs, memory dump analyzers, and the like.

When hardware errors occur, debugging software can be extremely difficult. For example, a hardware error can cause an abort, which terminates operation of system. In some systems, a hardware error may trigger the system to enter a debugger routine. When a system abort occurs due to a memory error, the typical system behavior is to halt all processors and restart the machine. In complex systems, having many different concurrent tasks, the software developer can be left with little idea as to what caused the failure.

### BRIEF DESCRIPTION OF THE DRAWINGS

FIG. 1 is a block diagram of a computer system error handler for handling severe hardware errors in accordance with an embodiment of the present invention;

FIG. 2 is listing of a debug file in accordance with an embodiment of the present invention; and

FIG. 3 is a flow chart of a method of handling severe hardware errors communicated to an operating system in accordance with an embodiment of the present invention.

### DETAILED DESCRIPTION OF EXAMPLE EMBODIMENTS

Reference will now be made to the exemplary embodiments illustrated, and specific language will be used herein to describe the same. It will nevertheless be understood that no limitation of the scope of the invention is thereby intended.

In view of the difficulties presented by debugging complex computer systems when hardware errors are present, the present system and method enables the handling of some severe hardware errors through a computer operating system. Accordingly, embodiments of the present system and method include computer system error handlers and methods for handing severe hardware errors.

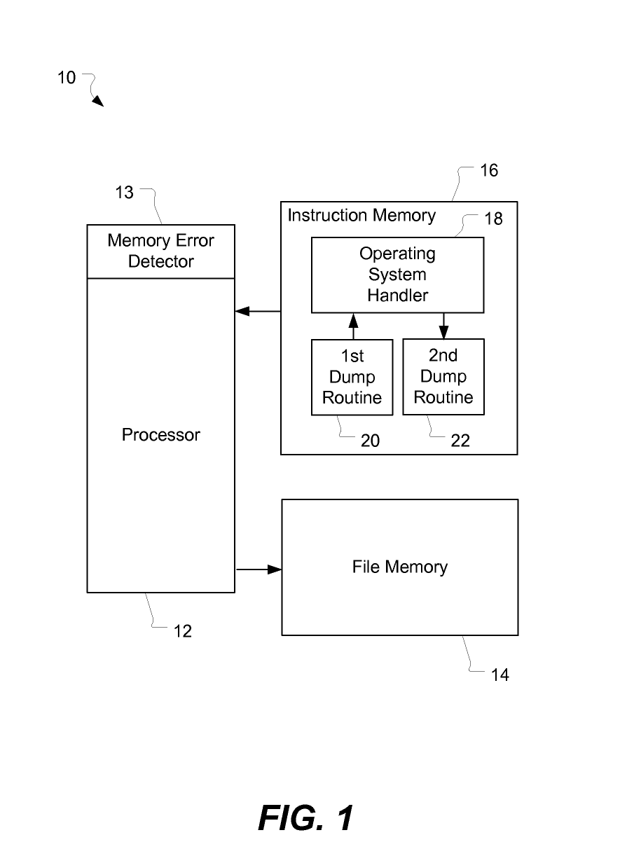

FIG. 1 illustrates a computer system in accordance with an embodiment of the present invention. The computer system 10 includes a processor 12 configured to execute computer-readable instructions. The processor includes a memory error detector 13, which can generate a machine check abort when a memory error occurs in an affected memory section. Some processors provide an integrated memory controller, while other processors may be augmented with external memory controllers to provide a memory checking ability. Various memory error types may be detected, including for example, a parity error, a bus error, an uncorrectable memory error, an error correcting code failure, and the like. The memory error types detected by different memory controllers may vary depending on the differing error detection capability of each memory controller. When a memory error occurs, the processor may receive an error notification to take remedial action.

A memory error will affect a section of memory. The affected section may be, for example, a physical memory location (address) or a physical block of memory (range of addresses).

Coupled to the processor 12 are a file memory 14 and an instruction memory 16. Data can be stored in the file memory under control of the processor. For example, the file memory may be a random access memory, a disk drive, an erasable programmable memory, or the like. The instruction memory includes computer-readable instructions stored therein that can be executed by the processor. The instruction memory may be, for example, read only memory, random access memory, or the like. The file memory and instruction memory may be the same physical memory. The file memory and instruction memory may be included in whole or in part within a processor chip.

The computer readable instructions stored within the instruction memory 16 include an operating system handler 18 to classify an abort into either a memory-related error or a non-memory related error and to execute a dump routine. There are two dump routines: a first dump routine 20 and a second dump routine 22. The first dump routine writes a dump file into the file memory 14 for an affected process when the type of abort is a non-memory-related error. The second dump routine writes a debug file into the file memory that includes error cause information for the affected process without accessing affected memory when the type of abort is a memory-related error.

The handling of memory-related errors by writing information into a debug file will provide considerable assistance to software developers and system administrators in debugging the cause of the severe hardware error. This is in contrast to simply causing the processor to halt, which would provide little information related to the cause of the error. Providing some type of output file when a software failure occurs is a familiar type of behavior: when an application terminates, software developers are accustomed to seeing a core dump file created. The present system extends this functionality to critical hardware failures.

It is helpful to handle memory-related errors differently than non-memory-related errors. For example, non-memory-related errors cause a dump file to be written. A dump file is a memory dump of the entire affected process memory. Such behavior can be a default mode of error handling. Typically, the entire dumpable physical address space of a process is traversed and written to a dump file.

Writing a dump file, of course, involves accessing the affected process memory. When a memory problem exists, accessing memory can, however, result in additional memory errors and cause recursive calls to the dump routine. The dump routine would thus repeatedly write partial, incomplete, dump files. This undesirable situation is avoided by handling the memory-related errors separately, and creating a specialized debug file. The specialized debug file is created without accessing affected memory, thus helping to avoid recursive hardware failures when a memory section is error prone. In other words, the default behavior of generating a dump file is modified to create a specialized debug file for the situation where a memory-related error has occurred. The resulting debug file provides information to developers and system administrators to help them identify the cause of the underlying error.

The debug file can include information available to the processor which does not need to be read from the affected memory. For example, the debug file can include a program name, a process executable name, an address fault location, a segment being accessed, a type of segment being addressed, a type of machine check abort, or any of the above. This type of information can also be more helpful in determining the cause of the severe hardware error than a dump of the affected memory.

The same kind of error detection and recovery can apply to other hardware errors coming from parts of the computer like the processor.

The dump file and the debug file can be written using a common header format to simplify post-abort analysis. For example, the dump file and/or debug file can be displayed and read by a user using a text editor, debugger, analysis tool, or the like.

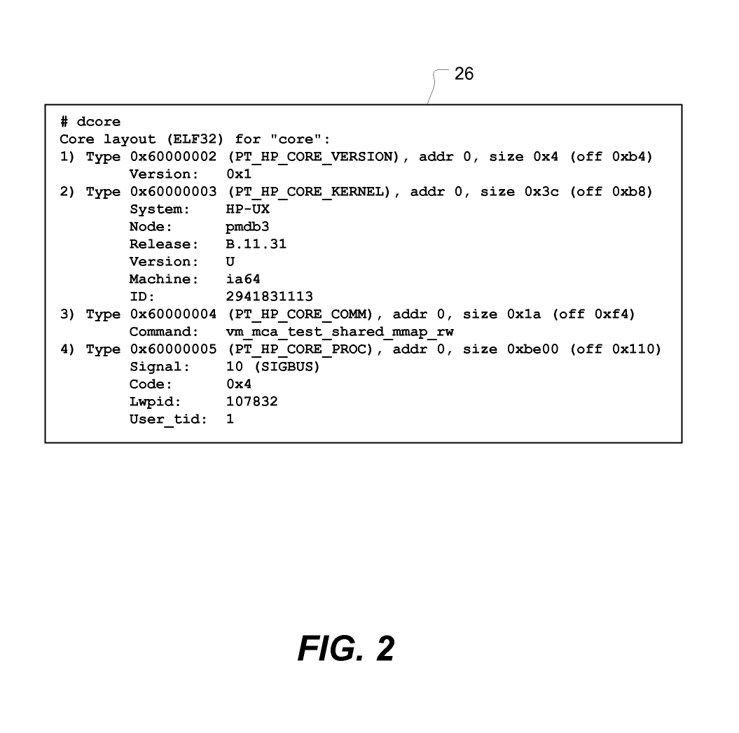

FIG. 2 provides an example debug file 26. Four segment types are defined for the debug file. The first segment (numbered 1) identifies the version of the debug file being written. This allows for forward compatibility, where new features can be added to the debug file in later versions. The second segment (numbered 2) identifies the operating system type, here identified as the HP-UX operating system, operating on node “pmdb3”, release, version, processor, and ID information is also provided. The third segment (numbered 3) identifies the name of the application executable that was running at the time of the fault. The fourth segment (numbered 4) indicates the signal that was send through the operating system, and the code for the type of fault (here, 0×4 indicates a “machine check abort”). Other types of codes may indicate other types of failures that can be detected. Note that the dump file may be written using the same header.

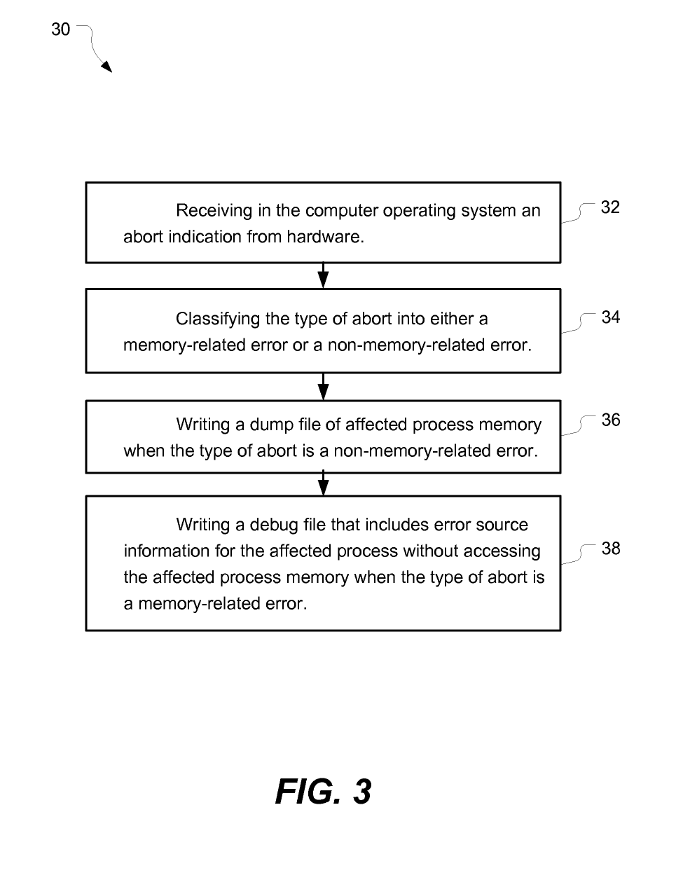

FIG. 3 illustrates a flow chart of a method for handling severe hardware errors communicated to a computer operating system. The method 30 can include the operation of receiving in the computer operating system an abort indication from hardware, as in block 32. For example, the abort indication may be a machine check abort interrupt. As another example, operating system routines or low level firmware may form a semaphore type signal with a machine check abort indication.

The method 30 can include classifying the type of abort into either a memory-related error or a non-memory-related error, as in block 34. For example, memory-related errors may include parity errors, bus errors, etc. as described above. Non-memory-related errors may include bus timeout errors, cache errors, and the like. An abort may include an indication of the type of abort, such as a predefined code stored within a processor register. Classifying the type of abort may be based on a predefined mapping of abort codes into memory or non-memory types.

The method 30 can include writing a dump file when the type of abort is a non-memory-related error, as in block 36, and writing a debug file when the type of abort is a memory-related error, as in block 38. Writing a dump file is of the affected process memory. Writing a debug file includes error source information for the affected process, but is written without accessing the affected process memory. The dump file and debug file may, for example, be written to a disk.

The method 30 may include the additional steps of prohibiting further accesses to the affected process memory and resuming operation for unaffected processes. Prohibiting accesses to the affected process memory can help to avoid repeated aborts from occurring if there is a persistent memory problem. Various ways of prohibiting accesses may be implemented, including for example, setting flags within the operating system, freezing memory, or disabling the affected process from further execution.

Resuming operation for unaffected processes may allow operation and debugging of software to continue, if desired. Resuming operation may, for example, be implemented by disabling the affected process within the operating system, and then performing a return from the interrupt sequence.

It should also be appreciated that there may be some low-level firmware that can handle a machine check abort, and allow a complete recovery. In such a case, the abort need not be signaled to the operating system.

Some applications may be capable of handing machine check aborts internally. Accordingly, the method can include determining if the affected process can handle the error, and if so, passing the error to the affected process for handing. More typically, however, the affected process will not be able to handle a severe hardware error, and the error will be handled as described above.

Of course, if the affected process is the operating system kernel, there is little point in attempting recovery, since the operating system may be in an inconsistent state. Accordingly, in such a case, the error is handled as described above without attempting any recovery.

The method 30 may be implemented in computer program code. For example, computer program code may be stored on a computer readable medium, such as non-volatile read only memory, erasable read only memory, programmable read only memory, or the like. The computer program code may be stored on a disk or other non-volatile memory device and loaded into volatile memory during operation of the processor. The computer program code may be included within an operating system, such as a version of the UNIX operating system, e.g. the HP-UX operating system.

Summarizing to some extent, techniques for handling severe hardware errors within a computer operating system have been described. Error cause information is written to a debug file, even when the cause of the error is a memory error. The error cause information is available without accessing affected memory sections, thus avoiding a recursive core dump situation. The resulting debug file information can be helpful to developers and system administrators in determining the cause and source of the error.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A method for handling severe hardware errors communicated to a computer operating system, comprising:
receiving in the computer operating system an abort indication from hardware;
classifying the type of abort into either a memory-related error or a non-memory-related error;
writing a dump file of affected process memory when the type of abort is a non-memory-related error; and
writing a debug file that includes error source information for the affected process without accessing the affected process memory when the type of abort is a memory-related error.

2. The method of claim 1, wherein the memory-related error is chosen from the group consisting of a parity error, a bus error, an uncorrectable memory error, an error correcting code error, and a segmentation violation error.

3. The method of claim 1, wherein receiving in the computer operating system an abort indication further comprises handling a machine check abort interrupt.

4. The method of claim 1, wherein receiving in the computer operating system an abort indication further comprises signaling an error.

5. The method of claim 1, wherein writing a debug file comprises outputting any one or more of the following: a program name, a process executable name, an address fault location, a segment being accessed, a type of segment being accessed, and a type of abort.

6. The method of claim 1, further comprising prohibiting further accesses to the affected process memory.

7. The method of claim 1, further comprising resuming operation for unaffected processes.

8. The method of claim 1, further comprising passing the abort to the affected process for affected processes that can handle the abort.

9. The method of claim 1, wherein the dump file and debug file are written with a common header format.

10. The method of claim 1, further comprising displaying the contents of the debug file on a display.

11. A computer readable medium comprising computer readable program code to implement the method of claim 1.

12. A computer system error handler for handling severe hardware errors, comprising:
a processor configured to execute computer-readable instructions and having a memory controller which can detect and generate a machine check abort when a memory error occurs in an affected memory section;
a file memory coupled to the processor and configured to store data therein under control of the processor;
an instruction memory coupled to the processor and having a plurality of computer-readable instructions stored therein, the computer readable instructions comprising:
an operating system handler to classify an abort into either a memory-related error or a non-memory-related error and execute a dump routine;
a first dump routine to write a dump file into the file memory for an affected process when the type of abort is a non-memory-related error; and
a second dump routine to write a debug file into the file memory, the debug file including error cause information for the affected process without accessing affected memory when the type of abort is a memory-related error.

13. The system of claim 12, wherein the instruction memory is a read only memory.

14. The system of claim 12, wherein the file memory is a disk.

15. The system of claim 12, wherein the second dump routine also writes any one or more of the following: a program name, a process name, an address fault location, a segment being accessed, a type of segment being accessed, and a type of abort.

16. A method for handling severe hardware errors communicated to a computer operating system, comprising:
receiving in the computer operating system an abort indication from hardware;
classifying the type of abort into either a memory-related error or a non-memory-related error; and
writing a debug file that includes error source information for the affected process without accessing the affected process memory when the type of abort is a memory-related error.

17. The method of claim 16, wherein writing a debug file comprises outputting any one or more of the following: a program name, a process name, an address fault location, a segment being accessed, a type of segment being accessed, and a type of abort.

18. The method of claim 16, wherein the debug file is written to a disk.

19. The method of claim 16, further comprising prohibiting further accesses to the affected process memory.

20. A computer system error handler for handling severe hardware errors comprising:
means for receiving in the computer operating system an abort indication from hardware;
means for classifying the received abort indication into either a memory-related error or a non-memory-related error;
means for writing a dump file of affected process memory when the type of abort is a non-memory-related error; and
means writing a debug file that includes error source information for the affected process without accessing the affected process memory when the type of abort is a memory-related error.

21. The method of claim 20, further comprising means for prohibiting further accesses to the affected process memory.
